(19) United States
(12) Patent Application Publication
(10) Pub. No.: US 2009/0088012 A1
(43) Pub. Date: Apr. 2, 2009

(54) CONNECTOR DEVICE AND ELECTRONIC APPARATUS

(75) Inventor: Toshiki Oooka, Hamura-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/171,187

(22) Filed: Jul. 10, 2008

(30) Foreign Application Priority Data
Sep. 28, 2007 (JP) 2007-255026

(51) Int. Cl. H01R 13/15; H01R 12/24

(52) U.S. Cl. 439/260; 439/492; 439/497

(57) ABSTRACT

According to one embodiment, a connector device includes a flexible cable, a housing, a containing portion, a wall portion, and a leaf spring. The containing portion is formed inside the housing, and a terminal of a counter connector device is inserted to the containing portion. The wall portion is opposed to the flexible cable, and forms one surface of the containing portion. The leaf spring is provided inside the containing portion, and adhered to a surface of the flexible cable reverse to a surface in which a conductor portion of the flexible cable is exposed. The leaf spring urges the flexible cable toward the wall portion to hold the terminal with the wall portion.

### CROSS-REFERENCE TO RELATED APPLICATIONS

This application is based upon and claims the benefit of priority from Japanese Patent Application No. 2007-255026, filed Sep. 28, 2007, the entire contents of which are incorporated herein by reference.

### BACKGROUND

1. Field

One embodiment of the invention relates to a connector device which enables high-speed transmission, and an electronic apparatus having the same.

2. Description of the Related Art

Jpn. Pat. Appln. KOKAI Pub. No. 2000-260511 discloses a connector device in which a connecting portion is formed by using an end portion of a flat cable. The connector device has a flat cable having an end portion with an exposed conductor portion, a metal plate-shaped member to which the flat cable is bonded, and a housing surrounding them. The plate-shaped member is almost S-shaped, and has a U-shaped portion having a closed bag shape in its upper portion. The flat cable is bonded along the inside of the U-shaped portion. The conductor portion of the flat cable is exposed at the bonded portion, and forms a female connector portion having a bag shape.

When a male pin is inserted into the connector portion, the pin is held from above and below by the conductor portion of the flat cable. Thereby, electric connection is secured between the connector and the pin.

However, the above conventional connector device is not aimed at use for high-speed transmission at all, and has a structure which may cause malfunction in signal transmission, such as the U-shaped portion. Specifically, the conventional connector device has a structure in which the male pin is held from above and below by two conductors in the U-shaped portion to bring the pin into conduction. Therefore, it is difficult to establish impedance matching in the U-shaped portion, and there is the possibility of causing delay of signal waveform and transmission loss. Thus, the conventional connector device cannot be used for high-speed transmission without any change, and is susceptible to improvement.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view of a portable computer according to a first embodiment.

FIG. 2 is an exemplary perspective view of the portable computer illustrated in FIG. 1, illustrating a state where a keyboard thereof is removed.

FIG. 3 is an exemplary perspective view of the portable computer illustrated in FIG. 2, illustrating a state where an HDD thereof is removed.

FIG. 4 is an exemplary enlarged perspective view of a connector device illustrated in FIG. 3.

FIG. 5 is an exemplary exploded perspective view of the connector device illustrated in FIG. 4.

FIG. 6 is an exemplary cross-sectional view of the connector device illustrated in FIG. 4, taken along line F6-F6 of FIG. 4.

FIG. 7 is an exemplary cross-sectional view illustrating a leaf spring and a flexible cable of the connector device illustrated in FIG. 6.

FIG. 8 is an exemplary cross-sectional view illustrating a state where a terminal of a counter connector device is inserted into the leaf spring and the flexible cable illustrated in FIG. 7.

FIG. 9 is an exemplary cross-sectional view of the leaf spring and the flexible cable illustrated in FIG. 7, taken along line F9-F9 of FIG. 7.

FIG. 10 is an exemplary cross-sectional view illustrating a leaf spring and a flexible cable of a portable computer according to a second embodiment.

### DETAILED DESCRIPTION

Various embodiments according to the invention will be described hereinafter with reference to the accompanying drawings. In general, according to one embodiment of the invention, a connector device includes a flexible cable, a housing, a containing portion, a wall portion, and a leaf spring. The containing portion is formed inside the housing, and a terminal of a counter connector device is inserted to the containing portion. The wall portion is opposed to the flexible cable, and forms one surface of the containing portion. The leaf spring is provided inside the containing portion, and adhered to a surface of the flexible cable reverse to a surface in which a conductor portion of the flexible cable is exposed. The leaf spring urges the flexible cable toward the wall portion to hold the terminal with the wall portion.

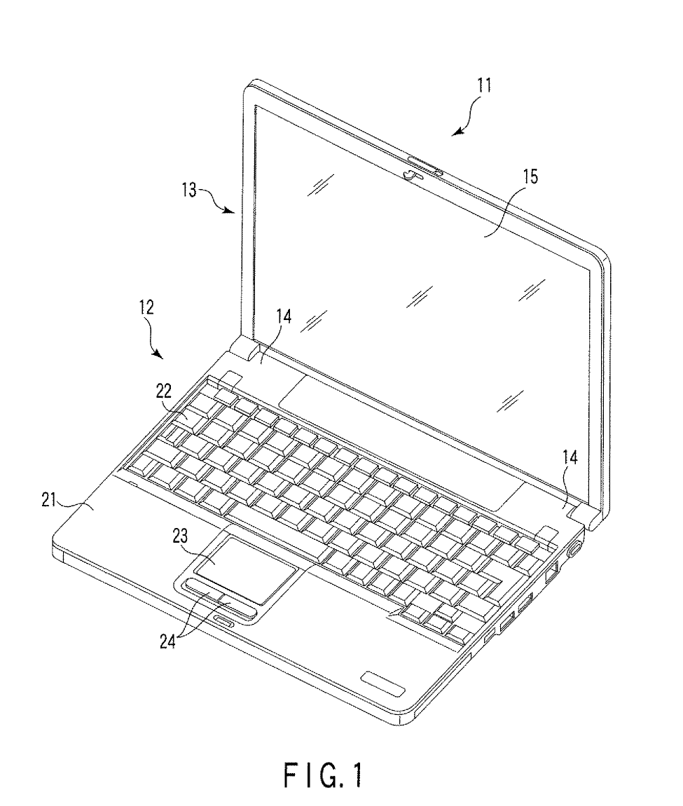

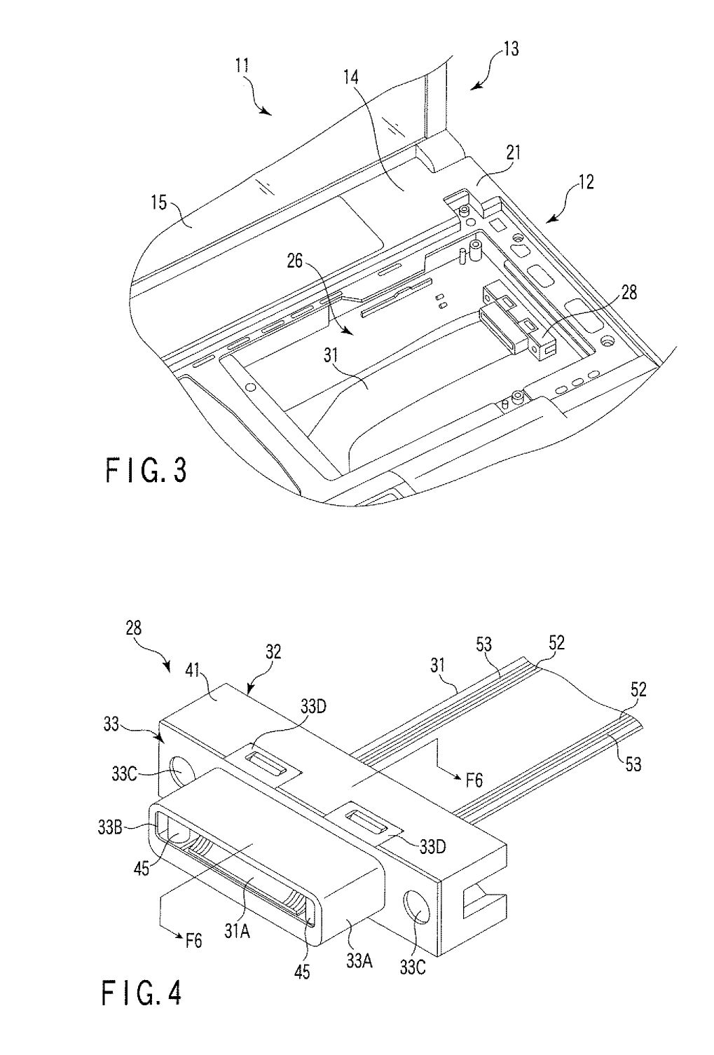

An embodiment of an electronic apparatus according to the present invention is explained with reference to FIGS. 1 to 9.

As illustrated in FIGS. 1 to 3, a portable computer 11 being an example of the electronic apparatus comprises a main body unit 12, a display unit 13, and hinge portions 14 provided between the main body unit 12 and the display unit 13. The hinge portion 14 rotatably supports the display unit 13. The display unit 13 has a liquid crystal display 15.

The main body unit 12 has a housing 21 made of resin, a keyboard 22, a touch pad 23 and buttons 24 serving as pointing devices, a printed circuit board 25 contained inside the housing 21, an HDD mounting portion 26 formed in the housing 21, a hard disk device 27 (hard disk drive [HDD]) mounted to the HDD mounting portion 26, and a connector device 28 which is provided in the HDD mounting portion 26 and adjacent to the housing 21. The HOD 27 has a second connector device 29 serving as a counter to which the connector device 28 is connected.

The connector device 28 is connected to the second connector device 29 being the counter, and can perform high-speed transmission with the second connector device 29. As illustrated in FIGS. 4 to 7, the connector device 28 has a flexible cable 31 having an end portion at which a conductor portion is exposed, a housing 32 which surrounds the end portion of the flexible cable 31, a metallic shell 33 which serves as an outside enclosure of the housing 32, a containing portion 34 formed in the housing 32, a wall portion 35 which forms one surface of the containing portion 34, a leaf spring 36 disposed in the containing portion 34, and an adhesive 37 which adheres the leaf spring 36 to the flexible cable 31. The metallic shell 33 has a projecting portion 33A projecting forward, a through hole 33B through which a terminal of the second connector device 29 is inserted, screw holes 33C used for fixing the metallic shell 33 to the housing 32, and engaging portions 33D to be engaged with the housing 32.

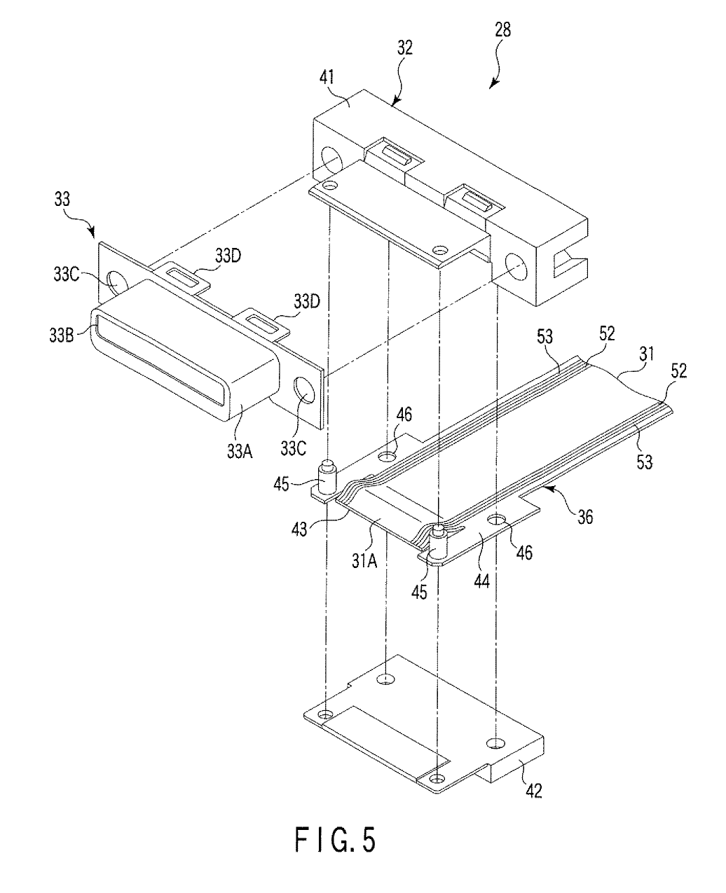

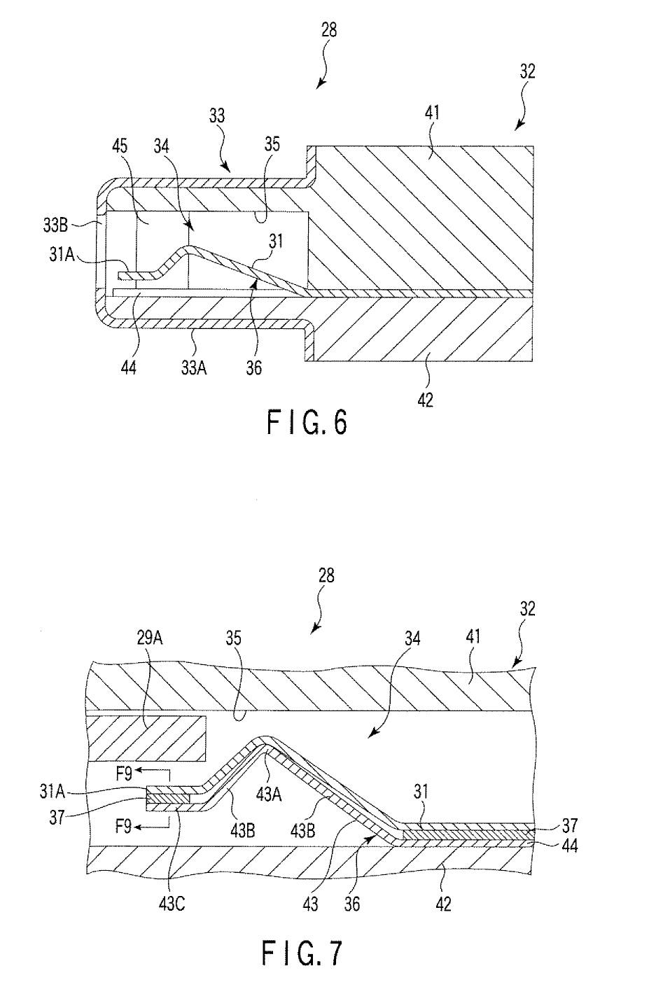

As illustrated in FIG. 5, the housing 32 has a housing main body 41 which is provided on the flexible cable 31, and a base plate 42 which is provided under the flexible cable 31. Each of the housing main body 41 and the base plate 42 is formed of a molded product obtained by molding synthetic resin, and is insulated. The housing 32 surrounds an end portion 31A of the flexible cable 31. As illustrated in FIG. 6, the housing 32 has the containing portion 34 inside, into which a terminal 29A of the second connector device 29 being the counter. The containing portion 34 has the wall portion 35, and the wall portion 35 forms one surface opposed to the flexible cable 31.

The leaf spring 36 is formed of a metal material. As illustrated in FIGS. 6 and 7, the leaf spring 36 is disposed inside the containing portion 34. As illustrated in FIG. 9, the leaf spring 36 is adhered to a surface of the flexible cable 31, which is located on the reverse side of a surface in which the conductor portion of the flexible cable 31 is exposed. As illustrated in FIG. 5, the leaf spring 36 has a leaf spring main body 43 which is curved to have a crest shape, and a support portion 44 which supports the leaf spring main body 43. The support portion 44 is formed to have a flat-plate shape. The support portion 44 has a pair of guide pins 45 to position itself with respect to the housing main body 41, and a pair of screw holes 46 to fix itself to the housing main body 41. As illustrated in FIG. 7, the leaf spring main body 43 has a top portion 43A which corresponds to the top of the crest, a pair of inclined surface portions 43B which are formed in positions adjacent to the top portion 43A, and a distal end portion 43C which connects directly with one inclined surface portion 43B. The other inclined surface portion 43B connects directly with the support portion 44. The leaf spring main body 43 is supported at one end by the support portion 44.

The leaf spring main body 43 is formed to have a crest shape which projects toward the wall portion 35. In other words, the leaf spring main body 43 has a shape to bring a part of the flexible cable 31 into contact with the terminal 29A inserted into the containing portion 34. Further, the leaf spring main body 43 has a shape to locate other portion of the flexible cable 31 gradually away from the terminal 29A inserted into the containing portion 34.

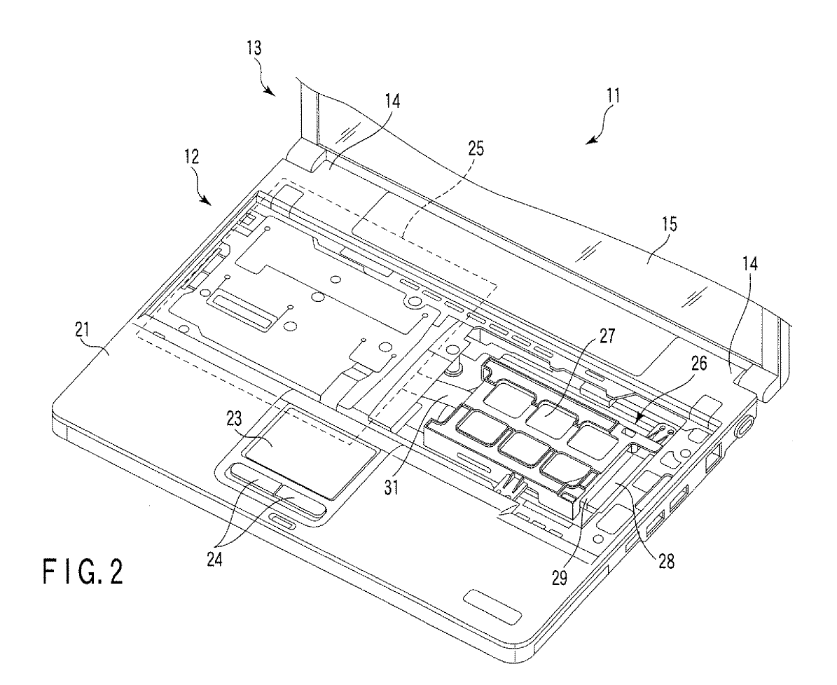

The flexible cable 31 is formed of a flexible flat cable (FFC), and a high-speed transmission cable ready for, for example, Serial ATA II. As illustrated in FIG. 2, the flexible cable 31 is connected with the printed circuit board 25 through a connector (not shown). As illustrated in FIG. 7, the flexible cable 31 has a shape conforming to the leaf spring 36. As illustrated in FIG. 9, the flexible cable 31 has an insulating base material layer 51, a pair of differential transmission lines 52 formed on the base material layer 51, and a pair of ground lines 53 which are arranged to surround the differential transmission lines 52 and adjacent to the respective differential transmission lines 52. As illustrated in FIG. 9, the flexible cable 31 exposes the differential transmission lines 52 and the ground lines 53, which are conductor portions, to the outside in the vicinity of the end portion 31A which corresponds to the top portion 43A and the inclined surface portions 43B of the leaf spring main body 43. The flexible cable 31 has a structure in which the surfaces of the differential transmission lines 52 and the ground lines 53 are covered with an insulating film in its intermediate portion.

On the base material layer 51, an insulating layer 54 is formed between the differential transmission lines 52 and the ground lines 53. A second insulating layer 55 is formed on a surface of the base material layer 51 reverse to the surface on which the differential transmission lines 52 and the ground lines 53 are formed. The flexible cable 31 is not limited to an FFC, but may be formed of a flexible printed wiring board or the like.

As illustrated in FIG. 7, adhesive 37 is interposed between the flexible cable 31 and the leaf spring 36. The flexible cable 31 is adhered to the leaf spring 36 by the adhesive 37.

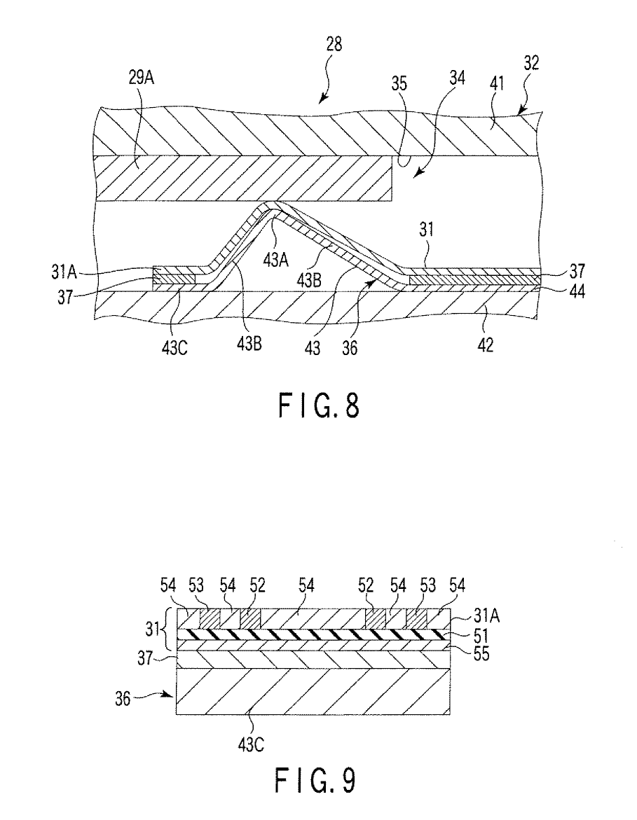

Next, explained is a step of inserting the terminal 29A of the second connector device 29 being the counter into the containing portion 34 inside the housing 32, with reference to FIGS. 7 and 8. When the terminal 29A is inserted into the containing portion 34, the distal end of the terminal 29A contacts the surface of the flexible cable 31. In insertion, the leaf spring 36 is pushed downward by the terminal 29A. In insertion, as illustrated in FIG. 8, the distal end portion 43C of the leaf spring 36 contacts the base plate 42 of the housing 32. When the terminal 29A of the second connector device 29 being the counter is inserted to the back, the leaf spring 36 urges the flexible cable 31 toward the wall portion 35, to hold the terminal 29A with the wall portion 35. The contact pressure between the flexible cable 31 and the terminal 29A is, for example, 0.3 to 1.0 N. Thereby, electric connection is secured between the conductor portion of the flexible cable 31 and the terminal 29A of the second connector device 29 being the counter.

According to the first embodiment, the portable computer 11 has the housing 21, and the connector device 28 which is contained inside the housing 21 and connected to and performs high-speed transmission with the second connector device 29 being the counter. The connector device 28 has a flexible cable 31 having the end portion 31A at which a conductor portion is exposed, the housing 32 which surrounds the end portion 31A of the flexible cable 31, the containing portion 34 which is formed inside the housing 32 and into which the terminal 29A of the second connector device 29 being the counter, the wall portion 35 which is opposed to the flexible cable 31 and forms one surface of the containing portion 34, and the leaf spring 36 which is provided inside the containing portion 34, adhered to a surface reverse to the surface of the flexible cable 31 in which the conductor portion thereof is exposed, and urges the flexible cable 31 toward the wall portion 35 to hold the terminal 29A with the wall portion 35.

According to the above structure, the conductor portion of the flexible cable 31 can be used as the connection terminal of the connector device 28. Thereby, it is unnecessary to perform soldering between the connection terminal and the flexible cable 31, and the assembly operation of the connector device 28 is simplified. Further, if a soldered portion is provided, a dielectric constant differs between the soldered portion and the flexible cable 31, and thus impedance mismatch occurs in this portion. According to the first embodiment, there is no impedance mismatching portion such as a soldered portion, and thus high-speed transmission can be smoothly performed. Further, since there is no soldered portion, space saving is achieved. Further, the first embodiment has the structure in which the terminal 29A of the second connector device 29 being the counter is held between the wall portion 35 of the containing portion 34 and the flexible cable 31, and thus the first embodiment has only one connecting portion between the terminal 29A and the conductor portion of the flexible cable 31. Thereby, no impedance mismatch occurs, and it is possible to prevent delay of signal waveform and transmission loss.

In this case, the flexible cable 31 has a pair of differential transmission lines 52 and a pair of ground lines 53 located to surround the differential transmission lines 52, and has a shape conforming to the shape of the leaf spring 36. The leaf spring 36 has a shape to bring a part of the flexible cable 31 into contact with the terminal 29A inserted into the containing portion 34, and locate other portions gradually away from the terminal 29A.

According to the above structure, the flexible cable 31 can be disposed such that the ground lines 53 are located gradually away from the terminal 29A of the second connector device 29. Thereby, the distance between the terminal 29A and the ground lines 53 does not rapidly change. Therefore, it is possible to prevent occurrence of impedance mismatch as much as possible.

In this case, the leaf spring 36 has a crest shape which projects toward the wall portion 35. According to this structure, it is possible to easily form, by bend processing, the shape to locate the ground lines 53 of the flexible cable 31 gradually away from the terminal 29A.

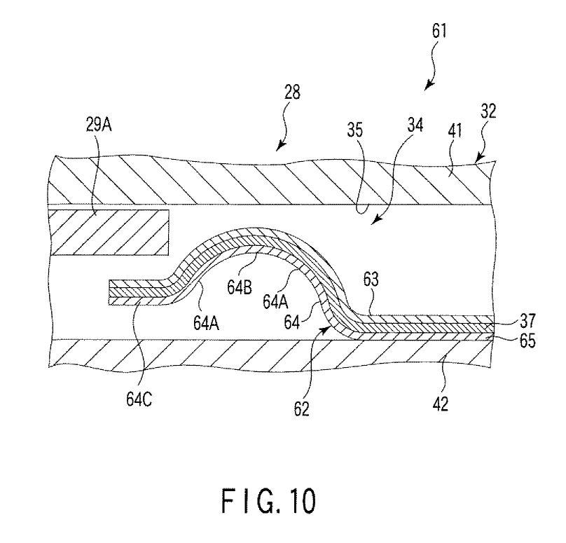

A second embodiment of the electronic apparatus is explained with reference to FIG. 10, with an example in which the second embodiment is applied to a portable computer 61. The portable computer 61 of the second embodiment is different from the first embodiment in the shape of a leaf spring 62 and the shape of a flexible cable 63 conforming to the shape of the leaf spring 62, but is the same as the first embodiment in other parts. Therefore, parts of the second embodiment which are different from those of the first embodiment are mainly explained, and parts which are the same as those of the first embodiment are denoted by the same respective reference numbers, and explanations thereof are omitted.

The portable computer 61 has an appearance equal to that illustrated in FIG. 1. The leaf spring 62 of the second embodiment is formed by subjecting a metal material to stamping. The leaf spring 62 has a leaf spring main body 64 which is curved to have a dome shape, and a support portion 65 which supports the leaf spring main body 64. The leaf spring main body 64 has an arc portion 64A having a dome shape, a top portion 64B which corresponds to the top of the arc portion 64A, and a distal end portion 64C which connects with the arc portion 64A. The leaf spring main body 64 has a dome shape which projects toward a wall portion 35 of a containing portion 34. In other words, the leaf spring main body 64 has a shape to bring a part of the flexible cable 63 into contact with a terminal 29R inserted into the containing portion 34, in the vicinity of the top portion 64B. Further, the leaf spring main body 64 is formed to have a shape to locate other portions of the flexible cable 63 gradually away from the terminal 29A inserted into the containing portion 34.

The flexible cable 63 is formed of an FFC. As illustrated in FIG. 10, the flexible cable 63 has a shape conforming to the leaf spring 62. In the same manner as the structure illustrated in FIG. 9, the flexible cable 63 has an insulating base material layer 51, a pair of differential transmission lines 52 formed on the base material layer 51, and a pair of ground lines 53 which are located to surround the differential transmission lines 52 and adjacent to the respective differential transmission lines 52. The flexible cable 63 is not limited to an FFC, but may be formed of a flexible printed wiring board or the like.

An adhesive 37 is interposed between the flexible cable 63 and the leaf spring 62. The flexible cable 63 is adhered to the leaf spring 62 by the adhesive 37.

According to the second embodiment, the leaf spring 62 is formed to have a dome shape which projects toward the wall portion 35. According to this structure, it is possible to easily form the shape to locate the ground lines 53 of the flexible cable 63 gradually away from the terminal 29A, by curving processing or stamping. Thereby, it is possible to prevent occurrence of impedance mismatch as much as possible in a part connecting the terminal 29A with the differential transmission lines 52 of the flexible cable 63, and smoothly perform high-speed transmission.

The electronic apparatus of the present invention is not limited to the portable computers 11 and 61 disclosed in the above embodiments, but may be other electronic apparatuses such as personal digital assistants. Further, the electronic apparatus can be carried out with various modifications within a range not departing from the gist of the invention. Specifically, the shapes of the leaf springs 36 and 62 and the flexible cables 31 and 63 are not limited to the above crest shape and dome shape, but may be of any shapes, as long as a part of the flexible cable 31 or 63 is brought into contact with the terminal 29A and other portions of the flexible cable are located gradually away from the terminal 29A.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A connector device which is connected to a counter connector device and performs high-speed transmission with the counter connector device, comprising:
a flexible cable having an end portion at which a conductor portion is exposed;
a housing which surrounds the end portion of the flexible cable;
a containing portion which is formed inside the housing, and to which a terminal of the counter connector device is inserted;
a wall portion which is opposed to the flexible cable and forms one surface of the containing portion; and
a leaf spring which is provided inside the containing portion, adhered to a surface of the flexible cable reverse to a surface in which the conductor portion is exposed, and urges the flexible cable toward the wall portion to hold the terminal with the wall portion.

2. A connector device according to claim 1, wherein
the flexible cable has a pair of differential transmission lines and a pair of ground lines located adjacent to the respective differential transmission lines, and has a shape conforming to a shape of the leaf spring, and
the leaf spring is formed to have a shape to bring a part of the flexible cable into contact with the terminal inserted into the containing portion, and locate other portions of the flexible cable gradually away from the terminal.

3. A connector device according to claim 2, wherein the leaf spring is formed to have a crest shape which projects toward the wall portion.

4. A connector device according to claim 2, wherein the leaf spring is formed to have a dome shape which projects toward the wall portion.

5. An electronic apparatus comprising:
a housing;
a connector device which is provided adjacent to the housing, connected to a counter connector device, and performs high-speed transmission with the counter connector device;
wherein the connector device includes:
a flexible cable having an end portion at which a conductor portion is exposed;
a housing which surrounds the end portion of the flexible cable;
a containing portion which is formed inside the housing, and to which a terminal of the counter connector device is inserted;
a wall portion which is opposed to the flexible cable and forms one surface of the containing portion; and
a leaf spring which is provided inside the containing portion, adhered to a surface of the flexible cable reverse to a surface in which the conductor portion is exposed, and urges the flexible cable toward the wall portion to hold the terminal with the wall portion.

6. An electronic apparatus according to claim 5, wherein
the flexible cable has a pair of differential transmission lines and a pair of ground lines located adjacent to the respective differential transmission lines, and has a shape conforming to a shape of the leaf spring, and
the leaf spring is formed to have a shape to bring a part of the flexible cable into contact with the terminal inserted into the containing portion, and locate other portions of the flexible cable gradually away from the terminal.

7. An electronic apparatus according to claim 6, wherein the leaf spring is formed to have a crest shape which projects toward the wall portion.

8. An electronic apparatus according to claim 6, wherein the leaf spring is formed to have a dome shape which projects toward the wall portion.
